(19) United States
(12) Patent Application Publication
(10) Pub. No.: US 2004/0070167 A1
(43) Pub. Date: Apr. 15, 2004

(54) Reinforcement front fork and suspension device

(76) Inventor: Jack Lin, Aliso Viejo, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/627,664

(22) Filed: Jul. 28, 2003

Related U.S. Application Data
(63) Continuation-in-part of application No. 10/178,357, filed on Jun. 25, 2002, now abandoned.

(51) Int. Cl. B62K 21/20

(52) U.S. Cl. 280/276

(57) ABSTRACT

A front suspension fork for bicycles includes a crown portion having two collars and two operation tubes are connected to the two collars. Two main tubes each have an open top through which two resilient members and the two operation tubes are received. A bridge is integrally formed in one piece formation with the two main tubes. The bridge is located in the same plane with the two main tubes and the two collars. The bridge has a curve top which has the same curvature as a lower profile of the crown portion.

### FIELD OF THE INVENTION

This application is a Continuation-In-Part application for applicant's former application with application number Ser. No. 10/178,357, filed on Jun. 25, 2002 and having a title of “front suspension device for bicycles”.

### BACKGROUND OF THE INVENTION

A conventional bicycle front suspension device 10 designed for the down-slope mountain bikes is shown in FIG. 1 and generally includes two crowns 11, 12 between which two main tubes 13 are connected. Two springs are respectively mounted to the two main tubes 13 and biased between the crowns 12 and a collar on each of the main tubes 13. A connection member 14 is connected between the two main tubes so that the brake mechanism can be connected to the connection member 14. This dual-crown type front suspension device is sold at high price and cannot be installed to regular bicycle frames. FIGS. 2 and 3 show another front suspension device 20 which includes two main tubes connected to the crown of the front fork and suspension members are mounted on the two main tubes. A connection member 24 has two collar portions 22 which are mounted to the two main tubes and two rods 23 extend from the connection member 24 so as to be connected with brake arms respectively. As shown in FIG. 3, the connection member 24 is located in front of the two collar portions 22 and the main tubes. In other words, the connection member 24 and the main tubes are located on two different planes, and this could be suffered by stress concentration.

U.S. Pat. No. 4,512,592 shows a connecting member 11 connected between the two fork pipes 2 by bolts 14 extending through the connecting member and connected to the brackets 9 on the fork pipes. U.S. Pat. No. 4,705,285 shows a stabilizer 6 connected between the fork members 3 by bolts. U.S. Pat. No. 5,715,903 shows a cross member 124 connected the two fork members by bolts 126. The disclosures in the prior arts have a common structure which is that the connecting member is connected to the fork member by additional securing members such as bolts, and it is expectable that the bolts are easily loosened from positioning the connecting member because the two fork members frequently and severely vibrate during riding of the bicycles. Even one of the bolts is loosened, the purpose that the connecting member bears is gone and the loosened connecting member could totally drop and tangled into the front wheel if the rider does not notice the situation.

U.S. Pat. No. 2003/0071400 shows an arch portion 14 connected between the two outer fork sections 6a, 8a. Nevertheless, the arch portion 14 extends inclinedly from the plane on which the fork sections are located. This arch portion does not reinforce the structural strength of the front fork at all.

The present invention intends to provide a reinforcement front fork that has a reinforcement bridge integrally formed in one piece formation with the two main tubes of the front fork and the bridge is located at the same plane of the two main tubes so that the device has better structural strength to bear high and frequent stress during operation.

### SUMMARY OF THE INVENTION

In accordance with one aspect of the present invention, there is provided a front fork for bicycles and the front fork comprises a crown portion having two collars and two operation tubes are connected to the two collars. Two main tubes each have an open top and a bridge integrally connected between peripheral portions of the open tops of the two main tubes. The two operation tubes are movably received in the two main tubes via the two respective open tops of the two main tubes. The bridge is located in the same plane with the two main tubes and the two collars. The bridge has a curve top which has the same curvature as a lower profile of the crown portion.

Two resilient members are respectively received in the two main tubes and the two operation tubes are pressingly disposed on the two resilient members.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional dual-crown front suspension device;

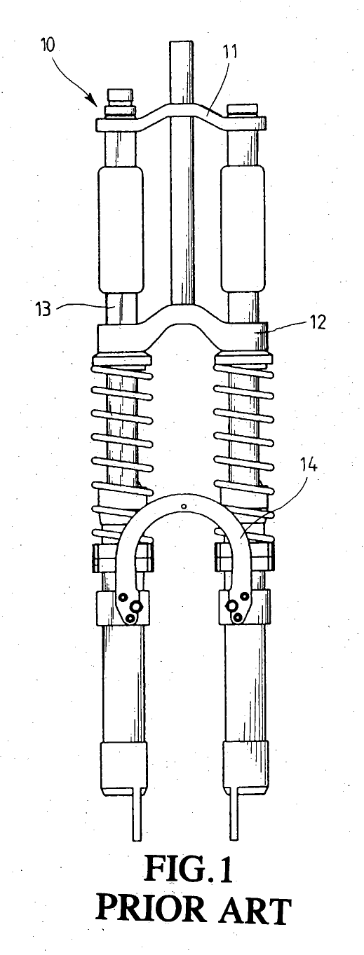

FIG. 2 shows another conventional front suspension device;

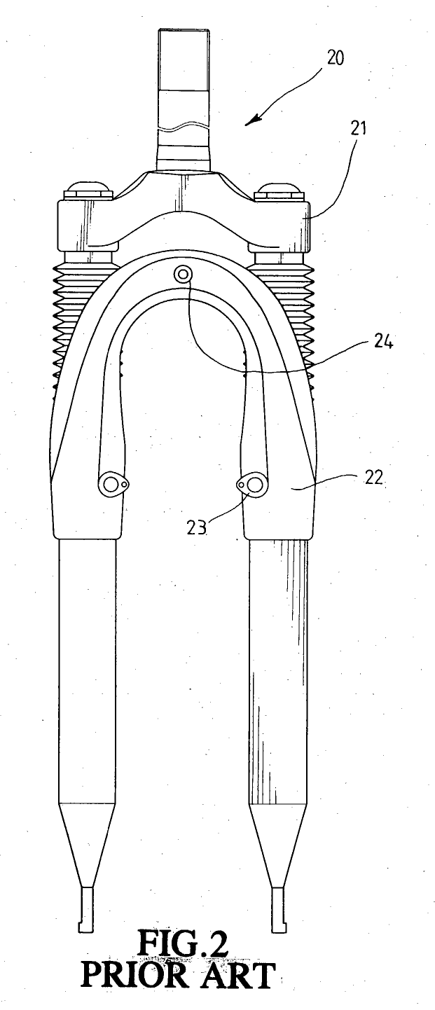

FIG. 3 shows a side view of the front suspension device as shown in FIG. 2;

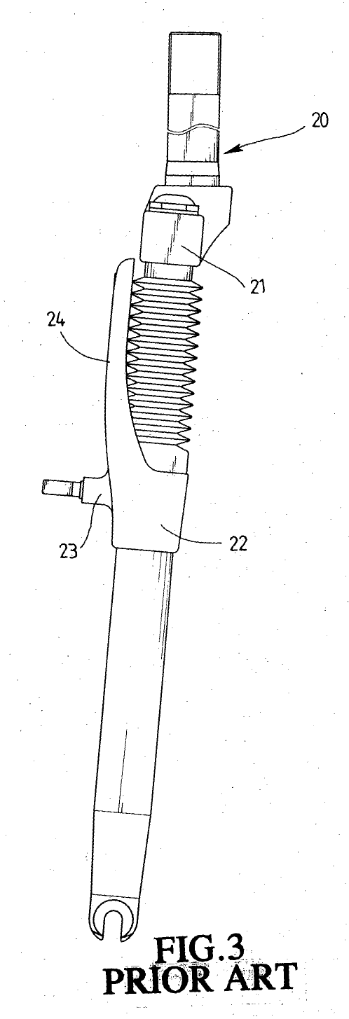

FIG. 4 is an exploded view to show the front suspension fork of the present invention;

FIG. 5 is a perspective view to show the front suspension fork of the present invention, and

FIG. 6 shows a side view of the front suspension fork of the present invention.

### DETAILED DESCRIPTION OF THE PREFERRED EMBODIMENT

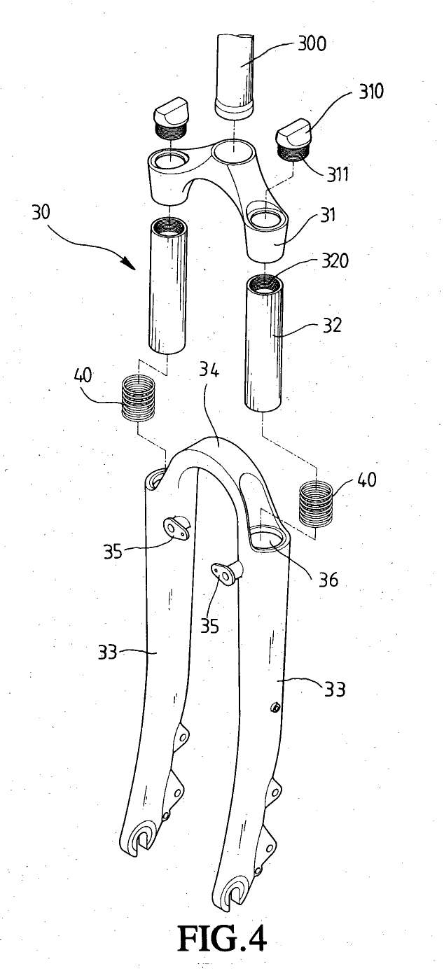

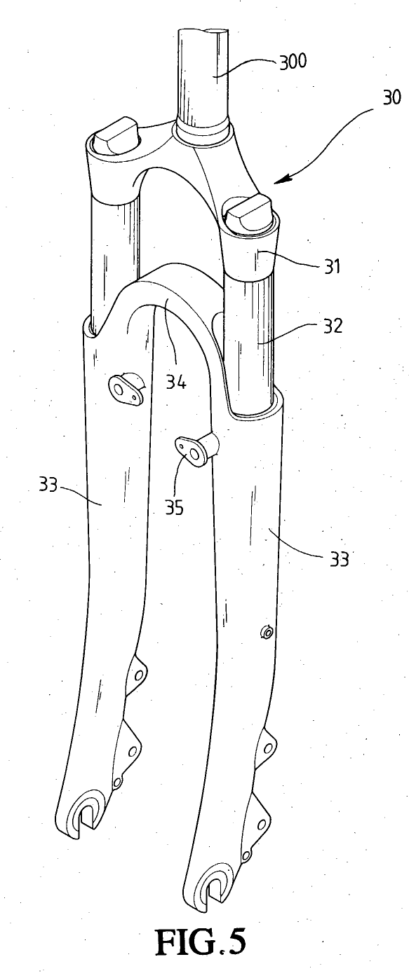

Referring to FIGS. 4 and 5, the front suspension fork for bicycles of the present invention comprises a front fork 30 which includes a crown portion with a steerer tube 300 extending from a top thereof and two collars 31 are located at two ends of the crown portion. Two securing members 310 are connected to the two collars 31 respectively and each securing member 310 has a threaded section 311. Two operation tubes 32 are inserted in the two collars 31 and each have a threaded inner periphery 320 which is engaged with the threaded section 311.

Two main tubes 33 each have an open top 36 and a bridge 34 is connected between the two. main tubes 33. The bridge 34 is integrally formed in one piece formation with two respective peripheral portions of the open tops 36 of the two main tubes 33. Two resilient members 40 are respectively received in the two main tubes 33 via the open tops 36 and the two operation tubes 32 are movably received in the two main tubes 33 via the open tops 36. The lower ends of the two operation tubes 32 press on the two resilient members 40.

Each of the main tubes 33 has a connection frame 35 extending therefrom such that brake arms or other parts of the brake system (not shown) are connected to the connection frames 35.

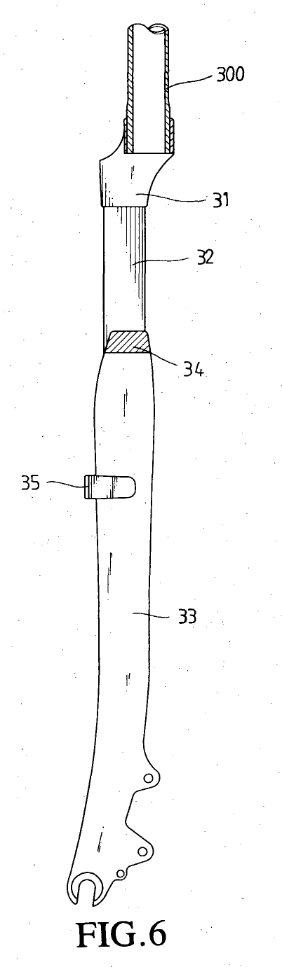

Further referring to FIG. 6, the bridge 34 is located in the same plane with the two main tubes 33 and the two collars 31. Therefore, when the two front tubes 33 are moved upward when the front wheel rolls over a protrusion, the resilient members 40 are compressed by the operation tubes 32 to absorb the shock transmitted to the bicycle.

It is to be noted that the bridge 34 has a curve top which has the same curvature as a lower profile of the crown portion so that the crown portion, the bridge 34 and the two parallel operation tubes 32 forms a rectangular frame which effectively reinforces the structural strength of the front fork.

While we have shown and described the embodiment in accordance with the present invention, it should be clear to those skilled in the art that further embodiments may be made without departing from the scope of the present invention.

What is claimed is:

1. A front suspension fork for bicycles, comprising:
a crown portion having two collars and two operation tubes connected to the two collars;
two main tubes each having an open top and a bridge connected between the two main tubes, the bridge and the two main tubes being integrally formed in one piece formation with the bridge being connected between peripheral portions of the open tops of the two main tubes, the two operation tubes being movably received in the two main tubes via the two respective open tops of the two main tubes, the bridge being located in the same plane with the two main tubes and the two collars, the bridge having a curve top which has the same curvature as a lower profile of the crown portion, and
two resilient members respectively received in the two main tubes and the two operation tubes being pressingly disposed on the two resilient members.

2. The device as claimed in claim 1 further comprising two securing members connected to the two collars and the operation tube inserted in the collar and fixed to the securing member.

3. The device as claimed in claim 2, wherein each securing member has a threaded section and each operation tube having a threaded inner periphery which is engaged with the threaded section.
